(19) United States
(12) Patent Application Publication
(10) Pub. No.: US 2020/0122521 A1
(43) Pub. Date: Apr. 23, 2020

(54) SYSTEM FOR ASSESSING THE CONDITION OF A VEHICLE, INSTALLED NEAR A ROAD INFRASTRUCTURE

(71) Applicant: COMPAGNIE GENERALE DES ETABLISSEMENTS MICHELIN, Clermont-Ferrand (FR)

(72) Inventors: THOMAS LEDOUX, Clermont-Ferrand (FR); NICOLAS FANGEAT, Clermont-Ferrand (FR)

(21) Appl. No.: 16/618,491

(22) PCT Filed: May 31, 2018
(86) PCT No.: PCT/FR2018/051263

§ 371 Date: Dec. 2, 2019

(30) Foreign Application Priority Data
Jun. 2, 2017 (FR) 1754914

(51) Int. Cl. B60C 11/24; G01M 17/02; G07C 5/00; G07C 5/08; B60C 23/04

(52) U.S. Cl. CPC B60C 11/246; G01M 17/02; B60C 23/0479; G07C 5/0825; G07C 5/008

(57) ABSTRACT

A system for assessing the condition of a vehicle comprises: a subsystem for measuring the condition of at least one tire of the vehicle, a subsystem for reading identification data of a tire and/or of the vehicle, and a subsystem for transmitting measured data and identification data to a remote database, the three subsystems being installed in one or more casings designed to be installed on or near a road infrastructure, at least one of the casings being designed to be installed in a mandatory travel zone of the road infrastructure.

### FIELD OF THE INVENTION

The present invention relates to a system for assessing the condition of a vehicle, installed on or near a road infrastructure. More precisely, the invention relates to such a system comprising a subsystem for measuring the condition of a tyre.

Within the meaning of the present invention, a subsystem for measuring the condition of a tyre is, for example, but in a non-limiting manner, a system that makes it possible to detect tyre wear, a system making it possible to detect tyre pressure, or a system making it possible to measure tyre speed.

Numerous vehicle diagnostics systems are known. In the case of wear, mention may be made of wear indicators present on tyres or manual devices for measuring the depth of rubber remaining on a tyre.

In the case of measuring pressure, mention may be made of the systems installed directly on vehicle wheels, which determine pressure by means of a pressure sensor and then send the information by radio frequency to the central electronic unit of the vehicle; onboard systems measuring the pressure of contact of tyres on the ground or, alternatively, manual manometers.

The present invention seeks to provide a system, notably a system that can be used by vehicle fleet managers, which can form part of a more global system for diagnosing the condition of a vehicle and of the latter's tyres. In point of fact, there are no known systems that currently allow the cross-checking of a range of information concerning the vehicle and its tyres.

Document US 2009/0000370 discloses a measurement system comprising a rolling bed designed for a vehicle to pass over it. It has been observed, however, that in the case of large vehicles it was sometimes necessary to use two distinct rolling beds for each of the sides of the vehicles and that such a system did not make it possible, when carrying out a measurement, to identify the side of the vehicle to which said measurement related.

The present invention thus seeks to remedy this drawback by proposing a system offering simpler conditions of use.

### BRIEF DESCRIPTION OF THE INVENTION

The invention thus proposes a system for assessing the condition of a vehicle, the system comprising:
a subsystem for measuring the condition of at least one tyre of the vehicle,
a subsystem for reading identification data of a tyre and/or of the vehicle,
a subsystem for transmitting measured data and identification data to a remote database,
   the three subsystems being installed in one or more casings designed to be installed on or near a road infrastructure, at least one of the casings being designed to be installed in a mandatory travel zone of the road infrastructure.

“Road infrastructure” and “mandatory travel zone” are understood to mean, for example, an infrastructure such as a motorway and zones that it is mandatory to pass through, such as a lane for paying a toll, a motorway access lane, service station access lanes, etc. An infrastructure is also understood to mean a carpark, with zones that it is mandatory to pass through such as underground or overhead carpark access lanes. An infrastructure is also understood to mean a service area or rest area beside a road or motorway. In this case, the mandatory travel zone may be a simple traffic lane and/or a lane leading to the area, embodied in the form of markings on the ground and/or physical obstacles.

Such placement offers a plurality of advantages:
first, this is a mandatory passage point of a road and makes it possible to ensure that vehicles pass over a measurement casing without having to divert vehicles from their customary path,
second, positioning near a road infrastructure makes it possible to utilize the pre-existing communication means and infrastructures at such sites. Thus, the subsystem for transmitting to a database is able to use a pre-existing telecommunications gateway.

Furthermore, motorway system management companies have information systems that include numerous data concerning meteorological conditions, the condition of the road, the identity of the vehicle owners, etc. The proximity of these information systems makes it possible to use these data to transmit them to a vehicle and/or to combine them with data measured during the passage of the vehicle, in order to determine value-added information for the vehicle driver or for any other service.

The measurement subsystem and the identification data reading subsystem are advantageously installed in the casing located in the running zone of the vehicle in order that measurements may be made at the moment when the vehicle passes over the casing.

The identification data reading subsystem comprises, for example, an RFID reader that makes it possible to read identifiers stored in RFID chips that may be installed on each of the tyres of the vehicle and/or on the vehicle itself. Advantageously, this reader comprises one or more reading antennae, chosen from linear or circular polarization antennae. Such antennae make it possible to read the RFID chips irrespective of the location of the latter on the vehicle and/or the tyres. Indeed, when a system according to the invention is used, the positioning of the RFID chips or tags on the vehicles cannot be assumed any more than can the position of the vehicle relative to the casing as the vehicle passes over said casing.

In an example of improvements to the identification data reading subsystem it is possible, for example, to have RFID antennae and/or readers positioned on either side of the vehicle.

In a particular embodiment, the subsystem for measuring the condition of at least one tyre of the vehicle is a subsystem for measuring tyre wear. However, the use could be envisaged of measurement subsystems allowing the determination of other values such as: the form, surface or length of the area of contact, the load carried by each tyre, the contact pressure in the area of contact or, alternatively, the vehicle speed.

Advantageously, the measurement subsystem comprises at least one sensor from the group comprising: an eddy current wear sensor, a variable reluctance wear sensor, a laser-based optical wear sensor, a pressure sensor, a local load sensor.

Eddy current sensors or variable reluctance sensors are particularly advantageous in the case of an exterior installation because they are unaffected by a thin layer of dust or dirt, typically a layer less than 1 millimetre thick. Such a feature is a genuine advantage in a system according to the invention because the ground over which vehicles travel at toll-collection barriers are generally not regularly cleaned owing to the difficulty of access.

In a particular embodiment, the system further comprises a data reception device installed in the vehicle. In this case, it is advantageous for the measured data transmission subsystem to comprise means for transmitting data to the data reception device installed on the vehicle.

Thus, the data measured when the vehicle passes may be transmitted not only to a remote database but also to the vehicle itself, in real time with respect to its passage over the measurement system.

In a preferred embodiment, the casing installed in the running zone is a casing of low height embedded in the ground over which vehicles travel, for example ground made from asphalt or concrete.

Such a casing architecture allows integration into the roadway, with no raised surface at ground level. Indeed, certain vehicles, such as snowploughs, for example, are unable to pass over travel surfaces where there are obstacles. The architecture proposed here makes it possible to remedy this problem.

### DESCRIPTION OF THE OPTIMUM EMBODIMENT OF THE INVENTION

Other advantages and embodiments of the invention will become apparent with the detailed description of FIGURES which is given in a non-limiting manner and shows one example of implementation of a system according to the invention.

In this example, a toll barrier 40 is provided with:
a device 30 for measuring tyre wear
an RFID reader 35
a device 36 for transmitting information.

The measuring device 30 is in the form of a casing placed on the ground, over which a vehicle is intended to travel. This casing also comprises the RFID reader 35.

In an illustrative embodiment not shown in the FIGURE, the casings containing the various subsystems are circular, and buried in the ground, such that the upper surface thereof is planar and located parallel with and slightly below the level of the roadway or level with the roadway.

The measurement subsystem comprises a sensor unit, or one or more lines of sensors, for example of eddy current sensors, or variable reluctance sensors, with a view to measuring wear at a plurality of points of the tyre.

In an alternative embodiment, the measurement subsystem comprises a unit sensor or one or more lines of pressure sensors installed in the zone designed to receive the area of contact of the tyres when rolling. It is thus possible to estimate tyre pressure.

The sensors and the management electronics of the device 30 are powered by mains electricity originating from the toll barrier 40.

The RFID reader 35 is provided with one or more linear or circular polarization RFID reading antennae. These antennae may be arranged at a plurality of positions in the road in the direction of the traffic such as to be able to sense the RFIDs mounted on the tyres more easily.

Advantageously, said antennae may be distributed over a running zone of up to 5 metres in length, but preferably 3 metres or less in length.

When a vehicle 10 runs over the device 30 for measuring wear, when passing through the toll barrier 40, the wear of the four tyres 20 is measured automatically by the measuring device 30.

Furthermore, when said vehicle 10 passes through the toll barrier 40, the RFID chips adhesively bonded to or integrated into the tyres 20 and the RFID chip 11 adhesively bonded to the vehicle 10 are read by the RFID reader 35 associated with the system 30 for measuring wear.

Once this identification and wear-level information has been captured, the data are transmitted to the vehicle 10 by means of the device 36 for transmitting data.

To this end, there are two possibilities:
Either the data are transmitted directly from the device 36 to the device 15 for transmitting and receiving data that is present on the vehicle 10.
Or the data are transmitted from the device 36 to a remote database 50 by means of a device 45 for transmitting data that is associated with the toll barrier 40.

It is pointed out, here, that the transmitting means 36 and 45 may be embodied in one single device.

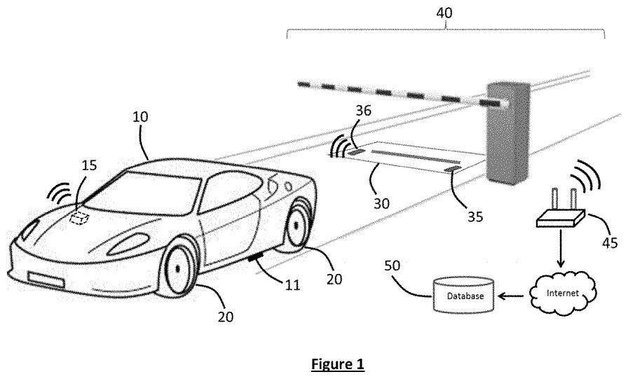

Once in the database 50, the data may then be retransmitted to the vehicle 10 using the data transmitting systems 45 and 15. In the example of FIG. 1, the vehicle 10 is equipped with means of communication with the driver of said vehicle, for communicating any type of information such as described previously in the present application.

1.-9. (canceled)

10. A system for assessing the condition of a vehicle, the system comprising:
a subsystem for measuring the condition of at least one tire of the vehicle;
a subsystem for reading identification data of at least one tire and/or of the vehicle; and
a subsystem for transmitting measured data and identification data to a remote database,
wherein the three subsystems are installed in one or more casings designed to be installed on or near a road infrastructure, at least one of the casings being designed to be installed in a mandatory travel zone of the road infrastructure.

11. The system according to claim 10, wherein the subsystem for reading identification data comprises an RFID reader.

12. The system according to claim 11, wherein the RFID reader comprises at least one reading antenna with linear or circular polarization.

13. The system according to claim 10, wherein the subsystem for measuring the condition of at least one tire of the vehicle is a subsystem for measuring tire wear.

14. The system according to claim 13, wherein the subsystem for measuring tire wear comprises at least one sensor from the group comprising of an eddy current wear sensor, a variable reluctance wear sensor, a laser-based optical wear sensor, a pressure sensor, and a load sensor.

15. The system according to claim 10 further comprising a data reception device installed in the vehicle.

16. The system according to claim 15, wherein the subsystem for transmitting measured data comprises means for transmitting data to the data reception device installed on the vehicle.

17. The system according to claim 16 further comprising means for displaying, in the vehicle, information designed for the driver, the information being determined as a function of the data received by the vehicle.

18. The system according to claim 10 further comprising means of communication with an external database and for receiving data from this database relating to the dimensions and characteristics of tires as a function of identification data.
